(19) United States
(12) Patent Application Publication
(10) Pub. No.: US 2026/0073204 A1
(43) Pub. Date: Mar. 12, 2026

(54) NEURAL PROCESSOR WITH TRANSPOSER FOR CONVERTING DATA LAYOUT FORMAT FOR PROCESSING

(71) Applicant: Apple Inc., Cupertino, CA (US)

(72) Inventors: Sayyed Karen KHATAMIFARD, Cupertino, CA (US); Jeffrey Dean Marker, Cupertino, CA (US); Thomas Gregory Anderl, Cupertino, CA (US); Keith Partick Wyss, Cupertino, CA (US); Diogo Martins Lourenco Real, Cupertino, CA (US); Gokul Krishnan, Cupertino, CA (US)

(73) Assignee: Apple Inc., Cupertino, CA (US)

(21) Appl. No.: 18/827,311

(22) Filed: Sep. 6, 2024

(51) Int. Cl. G06N 3/063

(52) U.S. Cl. CPC G06N 3/063

(57) ABSTRACT

Embodiments of the present disclosure relate to a neural processor circuit configured to switch between a width-last mode and a channel-last mode of input data for more efficient processing of tasks. A compiler may determine whether the neural processor circuit is likely to perform a task more efficiently by using the input data in a width-last format or the channel-last format and compiles instructions to enable or disable a transposer circuit in the neural processor circuit. When the neural processor circuit is in a mode that uses the channel-last format, the input data in the width-last format is transposed into transposed input data in the channel-last format before being fed into one or more neural engines of the neural processor circuit, and output data generated by the one or more neural engines are also transposed back into the width-last format.

### BACKGROUND

### 1. Field of the Disclosure

The present disclosure relates to a circuit for a neural processor for executing a neural network and more specifically to a neural processor that converts the data layout format of input data for efficient processing.

### 2. Description of the Related Arts

An artificial neural network (ANN) is a computing system or model that uses a collection of connected nodes to process input data. The ANN can be organized into layers where different layers perform different types of transformation on their input. Extensions or variants of ANN such as convolution neural networks (CNN), deep neural networks (DNN), recurrent neural networks (RNN) and deep belief networks (DBN) have come to receive much attention. These computing systems or models often involve extensive computing operations including multiplication and accumulation. For example, CNN is a class of machine learning technique that primarily uses convolution between input data and kernel data, which can be decomposed into multiplication and accumulation operations.

Depending on the types of input data and operations to be performed, these machine learning systems or models can be configured differently. Such varying configurations would include, for example, pre-processing operations, the number of channels in input data, the kernel data to be used, the nonlinear function to be applied to convolution result, and applying of various post processing operations. Using a central processing unit (CPU) and its main memory to instantiate and execute machine learning systems or models of various configurations is relatively easy because such systems or models can be instantiated with mere updates to code. However, relying solely on the CPU for various operations of these machine learning systems or models would not only consume significant bandwidth of the CPU but also increase the overall power consumption.

### SUMMARY

Embodiments relate to a neural processor circuit that operates in a first mode where raw input data is fed from a data buffer circuit to neural engine circuits without transposing the input data, and a second mode where the raw input data is transposed by a transposer circuit before being fed to the neural engine circuits. In the second mode, the raw input data stored in the data buffer circuit is transposed by the transposer circuit to generate transposed input data, and the transposed input data is sent to the neural engine circuits. Before the transposed input data is sent to the neural engine circuits, the transposed input data may be stored in the data buffer circuit. Output data generated by the neural engine circuits may be stored in the data buffer circuit before being sent to a memory that is external to the neural processor circuit. The raw input data may be in a width-last format and the transposed input data may be in a channel-last format.

### BRIEF DESCRIPTION OF THE DRAWINGS

Figure (FIG.) 1 is a high-level diagram of an electronic device, according to some embodiments.

FIG. 2 is a block diagram illustrating components in the electronic device, according to some embodiments.

FIG. 3 is a block diagram illustrating a neural processor circuit, according to some embodiments.

FIG. 4 is a block diagram of a neural engine in the neural processor circuit, according to some embodiments.

FIG. 5 is a block diagram illustrating a neural task manager in the neural processor circuit, according to some embodiments.

FIG. 6 is a diagram illustrating a task descriptor, according to some embodiments.

FIG. 7 is a block diagram illustrating a fetch queue and a configuration queue of the neural task manager, according to some embodiments.

FIG. 8A is a diagram illustrating input data in a width-last format, according to some embodiments.

FIG. 8B is a diagram illustrating the input data in a channel-last format, according to some embodiments.

FIG. 9 is a flowchart illustrating a method of generating a task descriptor to determine the mode of operation for the neural processor circuit, according to some embodiments.

FIG. 10 is a flowchart illustrating a method of performing neural network operations at the neural processor circuit using different data layout formats, according to some embodiments.

The figures depict, and the detailed description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural processor circuit configured to switch between a width-last mode and a channel-last mode of input data for more efficient processing of tasks. A compiler may determine whether the neural processor circuit is likely to perform a task more efficiently by using the input data in a width-last format or the channel-last format, and compiles instructions to enable or disable a transposer circuit in the neural processor circuit. When the neural processor circuit is in a mode that uses the channel-last format, the input data in the width-last format is transposed into transposed input data in the channel-last format before being fed into one or more neural engines of the neural processor circuit, and output data generated by the one or more neural engines are also transposed back into the width-last format.

A “task” described herein refers to a processing operation of the neural processor circuit that instantiates a network layer of a neural network, multiple network layers of a neural network, or a portion of a network layer of a neural network. A task list described herein refers to a sequence of tasks, such as a sequence of tasks that are executed by the neural processor circuit to instantiate multiple network layers of a neural network.

### Exemplary Electronic Device

Embodiments of electronic devices, user interfaces for such devices, and associated processes for using such devices are described. In some embodiments, the device is a portable communication device, such as a mobile telephone, that also contains other functions, such as personal digital assistant (PDA) and/or music player functions. Example embodiments of portable multifunction devices include, without limitation, the iPhone®, iPod Touch®, Apple Watch®, and iPad® devices from Apple Inc. of Cupertino, California. In other embodiments, the device is wearables such as a smartwatch or wireless earbuds. In some embodiments, the device is not a portable communications device, but is a desktop computer or other computing device that is not designed for portable use. In some embodiments, the disclosed electronic device may include a touch sensitive surface (e.g., a touch screen display and/or a touch pad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

Figure (FIG.) 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or to initiate an unlock process. In some embodiments, device 100 also accepts verbal input for activation or deactivation of some functions through microphone 113. Device 100 includes various components including, but not limited to, a memory (which may include one or more computer-readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include components not shown in FIG. 1.

Device 100 is only one example of an electronic device, and device 100 may have more or fewer components than listed above, some of which may be combined into a single component or have a different configuration or arrangement. The various components of device 100 listed above are embodied in hardware, software, firmware or a combination thereof, including one or more signal processing and/or application-specific integrated circuits (ASICs).

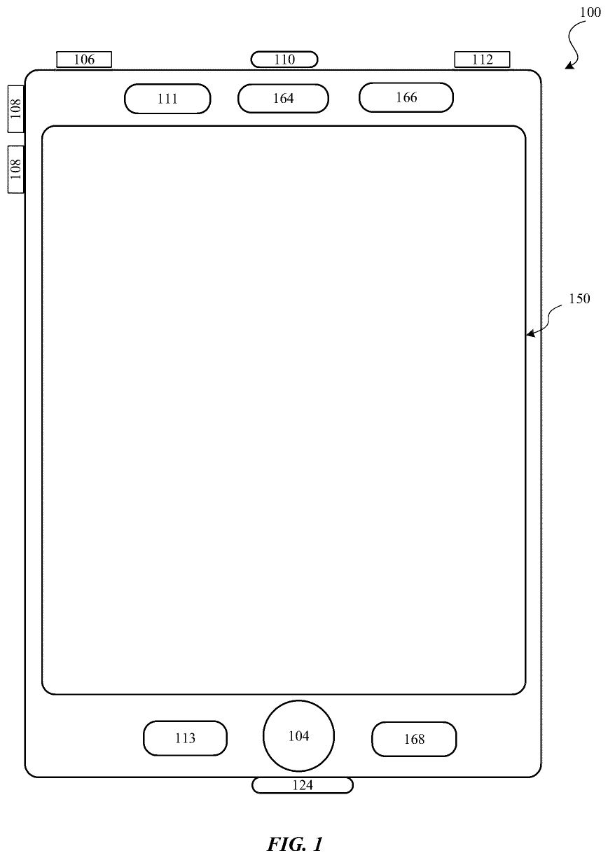

FIG. 2 is a block diagram illustrating components in device 100, according to some embodiments. Device 100 may perform various operations including image processing. For this and other purposes, Device 100 may include, among other components, image sensor 202, system-on-a chip (SOC) component 204, system memory 230, persistent storage (e.g., flash memory) 228, microphone 113, and display 216. The components as illustrated in FIG. 2 are merely illustrative. For example, device 100 may include other components (such as a speaker) that are not illustrated in FIG. 2. Further, some components (such as display 216) may be omitted from device 100.

Image sensor 202 is a component for capturing image data and may be embodied, for example, as a complementary metal-oxide-semiconductor (CMOS) active-pixel sensor in a camera, video camera, or other devices. Image sensor 202 generates raw image data that is sent to SOC component 204 for further processing.

Display 216 is a component for displaying images as generated by SOC component 204. Display 216 may include, for example, liquid crystal display (LCD) device, an organic light emitting diode (OLED) device or micro-LED device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 230 may store pixel data or other image data or statistics in various formats. In some embodiments, system memory 230 includes a compiler 336. Compiler 336 is architected to generate machine code for programming various parts of SOC component 204, as will be further described below.

Persistent storage 228 is a component for storing data in a non-volatile manner.

Persistent storage 228 retains data even when power is not available. Persistent storage 228 may be embodied as read-only memory (ROM), flash memory or other non-volatile random access memory devices.

SOC component 204 is embodied as one or more integrated circuit (IC) chips and performs various data processing operations. SOC component 204 may include, among other subcomponents, image signal processor (ISP) 206, central processor unit (CPU) 208, network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is hardware that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

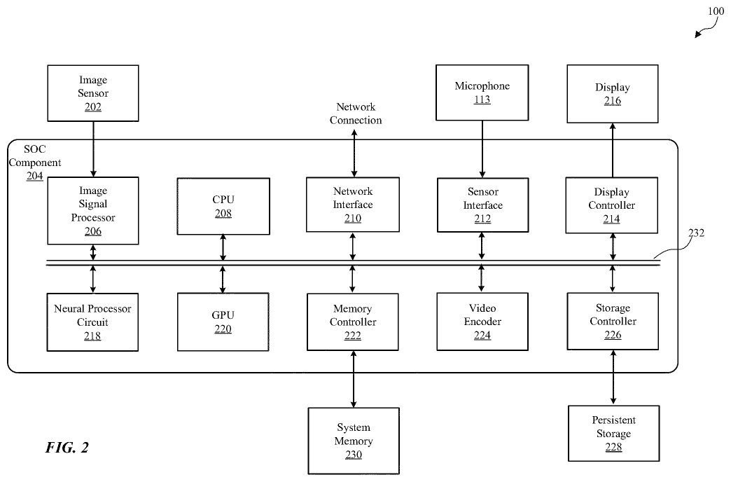

Neural processor circuit 218 is a circuit that performs various machine learning operations based on computations including multiplication, addition and accumulation. Such computations may be arranged to perform, for example, convolution operations on input data using kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, system memory 230 or other sources such as network interface 210 or GPU 220. The output of neural processor circuit 218 may be provided to various components of device 100 such as the image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video and other image data or audio data may be received from other devices via network interface 210 and be stored in system memory 230 for subsequent processing and display. The networks may include, but are not limited to, Local Area Networks (LANs) (e.g., an Ethernet or corporate network) and Wide Area Networks (WANs).

Sensor interface 212 is circuitry for interfacing with motion sensor 234. Sensor interface 212 receives sensor information from various types of sensors (e.g., microphone 113) and processes the sensor information. The sensor information may be sent to other subcomponents of SOC component 204 (e.g., neural processor circuit 218) for further processing.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 128 or for passing the data to network interface 210 for transmission over a network to another device.

In some embodiments, one or more subcomponents of SOC component 204 or some functionality of these subcomponents may be performed by software components executed on ISP 206, CPU 208 or GPU 220. Such software components may be stored in system memory 230, persistent storage 228 or another device communicating with device 100 via network interface 210.

Image data or video data may flow through various data paths within SOC component 204. In one example, raw image data may be generated from the image sensor 202 and processed by ISP 206, and then sent to system memory 230 via bus 232 and memory controller 222. After the image data is stored in system memory 230, it may be accessed by video encoder 224 for encoding or by display 116 for displaying via bus 232.

### Example Neural Processor Circuit

Neural processor circuit 218 is a configurable circuit that performs neural network operations on the input data based at least on kernel data. For this purpose, neural processor circuit 218 may include, among other components, neural task manager 310, a plurality of neural engines 314A through 314N (hereinafter collectively referred as “neural engines 314” or individually as “neural engine 314”), kernel direct memory access (DMA) 324, data buffer 318, buffer DMA 320, and transposer 332. Neural processor circuit 218 may include other components not illustrated in FIG. 3 such as a separate circuit for performing specialized computation operations.

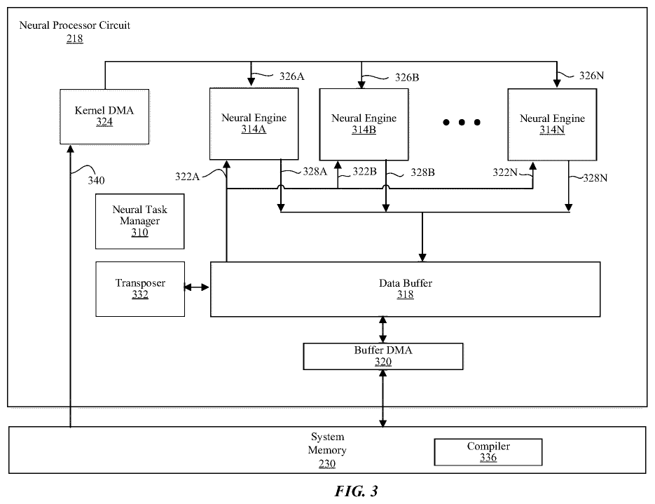

Each of neural engines 314 performs computing operations for neural network operations in parallel. Depending on the load of operation, entire set of neural engines 314 may be operated or only a subset of the neural engines 314 may be operated while the remaining neural engines 314 are placed in a power save mode to conserve power. For example, only neural engine 314A may operate in a mode (e.g., a channel-last mode where the input data is in a channel-last format) while the other neural engines 314B through 314N are placed in the power save mode. Further, at least one of neural engines 314 may have a hardware configuration different from that of other neural engines 314. For example, neural engine 314A may have bandwidth for that input data and/or bandwidth for kernel data 326A that are larger (e.g., double) than those of other neural engines 314B through 314N. That is, neural engine 314A may have a wider or faster signal line connected to data buffer 318 and/or kernel DMA 324 compared to signal lines in other neural engines 314B through 314N. Each of neural engines 314 includes components for storing one or more kernels, for performing multiply-accumulate operations, and for post-processing to generate output data 328, as described below in detail with reference to FIG. 4. One example of a neural network operation is a convolution operation.

Neural task manager 310 manages the overall operation of neural processor circuit 218. Neural task manager 310 may receive a task list from compiler 336 executed by CPU 208, store tasks in its task queues, choose a task to perform, and send instructions to other components of the neural processor circuit 218 for performing the chosen task. Neural task manager 310 may also perform switching of tasks on detection of events such as receiving instructions from CPU 208. In some embodiments, the neural task manager 310 sends rasterizer information to the components of the neural processor circuit 218 to enable each of the components to track, retrieve or process appropriate portions of the input data and kernel data. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In some embodiments, the kernel data may be in a compressed format which is decompressed at each of neural engines 314. Although kernel data provided to each of neural engines 314 may be the same in some instances, the kernel data provided to each of neural engines 314 is different in most instances.

Data buffer 318 is a temporary storage for storing data associated with the neural network operations. In some embodiments, data buffer 318 is embodied as a memory that can be accessed by all of the neural engines 314. Data buffer 318 may store input data received from system memory 230, input data 322A through 322N for feeding to corresponding neural engines 314A through 314N, as well as output data from each of neural engines 314A through 314N for feeding back into neural engines 314 or sending to a target circuit (e.g., system memory 230). Data buffer 318 may also store transposed versions of the input data and transposed versions of the output data from neural engines 314. The operations of data buffer 318 and other components of the neural processor circuit 218 are coordinated so that the input data and intermediate data stored in the data buffer 318 is reused across multiple operations at the neural engines 314, and thereby reducing data transfer to and from system memory 230. Data buffer 318 may be operated in a broadcast mode where input data of all input channels are fed to all neural engines 314 or in a unicast mode where input data of a subset of input channels are fed to each neural engine 314.

The input data 322 stored in data buffer 318 may be in a width-last format or a channel-last format. An example of a width-last format is an NCHW where N represents a batch or sample dimension, C represents a channel dimension, H represents a height dimension, and W represent a width dimension. NCHW format stores input data in a nested structure so that, for each sample, channels form the outer loop, the height dimension forms an inner loop, and the width dimension forms the innermost loop. An example of channel-last format is NHWC, which stores the input data in a nested structure so that, for each sample, the height dimension forms the outer loop, the width dimension forms the inner loop, and the channels form the innermost loop. The input data 322 may be raw input data received from system memory 230 or output data 328 generated in a prior cycle of the neural engines 314.

Buffer DMA 320 includes a read circuit that receives a portion of the input data from a source (e.g., system memory 230) for storing in data buffer 318, and a write circuit that forwards data from data buffer 318 to a target (e.g., system memory).

Transposer 332 is a circuit that reads input data or output data from data buffer 318 and transposes the input data or the output data into transposed input data or transposed output data. For example, transposer 332 reads input data or output data for a layer of a neural network in an NCHW format, performs a tensor transpose operation on the input data or the output data to convert the input data or output data into the transposed input data or the transposed output data in an NHWC format. The transposed input data or transposed output data may be stored in data buffer 318 and then be sent to neural engines 314 or to a target (e.g., system memory 230). Transposer 332 may also perform memory operations that involve no computation or only minimal computations on data stored in data buffer 318. Such memory operations may include, among other things, aligning or reordering data stored in data buffer 318.

### Example Neural Engine Architecture

FIG. 4 is a block diagram of neural engine 314, according to some embodiments.

Neural engine 314 performs various operations to facilitate neural network operations such as convolution, spatial pooling and local response normalization. Neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or multiple channels that can be in a width-last format.

Neural engine 314 may include, among other components, input buffer circuit 402, computation core 416, neural engine (NE) control 418, kernel extract circuit 432, accumulators 414 and output circuit 424. Neural engine 314 may include other components not illustrated in FIG. 4.

Input buffer circuit 402 is a circuit that stores a portion of input data 322 as it is received from the data buffer 318 and sends an appropriate portion 408 of input data for a current task or process loop to computation core 416 for processing. Input buffer circuit 402 includes a shifter 410 that shifts read locations of input buffer circuit 402 to change the portion 408 of input data sent to computation core 416. By changing portions of input data provided to the computation core 416 via shifting, neural engine 314 can perform multiply-accumulate for different portions of input data based on fewer read operations. Depending on the modes of operation, input data 322 stored in input buffer circuit 402 may have different data layout format.

Kernel extract circuit 432 is a circuit that receives kernel data 326 from kernel DMA 324 and extracts kernel coefficients 422. In some embodiments, kernel extract circuit 432 references a look up table (LUT) and uses a mask to reconstruct a kernel from compressed kernel data 326.

Computation core 416 is a programmable circuit that performs computation operations. For this purpose, computation core 416 may include MAD circuits MAD0 through MADN, and a post-processor 428. Each of MAD circuits MAD0 through MADN may store an input value in the portion 408 of the input data and a corresponding kernel coefficient in the kernel coefficients 422. The input value and the corresponding kernel coefficient are multiplied in each of MAD circuits to generate a processed value 412.

Accumulator 414 is a memory circuit that receives and stores processed values 412 from MAD circuits. The processed values stored in accumulator 414 may be sent back as feedback information 419 for further multiply and add operations at MAD circuits or sent to post-processor 428 for post-processing. Accumulator 414 in combination with MAD circuits form a multiply-accumulator (MAC) 404.

Post-processor 428 is a circuit that performs further processing of values 412 received from accumulator 414. The post-processor 428 may perform operations including, but not limited to, applying nonlinear functions (e.g., Rectified Linear Unit (ReLU)), normalized cross-correlation (NCC), merging the results of performing neural operations on 8-bit data into 16-bit data, and local response normalization (LRN). The result of such operations is output from the post-processor 428 as activation values 417 to output circuit 424.

NE control 418 controls operations of other components of the neural engine 314 based on the operation modes and parameters of neural processor circuit 218. Depending on different modes of operation (e.g., group convolution mode or non-group convolution mode) or parameters (e.g., the number of input channels and the number of output channels), neural engine 314 may operate on different input data in different sequences, return different values from accumulator 414 to MAC circuits, and perform different types of post-processing operations at post-processor 428. To configure components of the neural engine 314 to operate in a desired manner, the NE control 418 sends a control signal including configuration information to components of the neural engine. NE control 418 may also include rasterizer 430 that tracks the current task or process loop being processed at neural engine 314.

Output circuit 424 receives activation values 417 from the post-processor 428 and interfaces with data buffer 318 to store activation values 417 in data buffer 318. For this purpose, output circuit 424 may send out output data 328 in a sequence or a format that is different from the sequence or format in which activation values 417 are processed in post-processor 428.

The components in the neural engine 314 may be configured during a configuration period by the NE control 418 and the neural task manager 310. For this purpose, the neural task manager 310 sends configuration information to the neural engine 314 during the configuration period. The configurable parameters and modes may include, but are not limited to, mapping between input data elements and kernel elements, setting the number of input channels and the number of output channels, performing of output strides, and enabling/election of post-processing operations at post-processor 428.

### Example Neural Task Manager Architecture

A neural network may include network layers or sub-layers that are instantiated or implemented as a series of tasks executed by neural processor circuit 218. A neural network is converted, such as by compiler 336, to a task list. Each task is associated with a task descriptor that defines a configuration of the neural processor circuit 218 to execute the task. Each task may correspond with a single network layer of the neural network, a portion of a network layer of the neural network, or multiple network layers of the neural network. The neural processor circuit 218 instantiates the neural network by executing the tasks of the task list under the control of neural task manager 310.

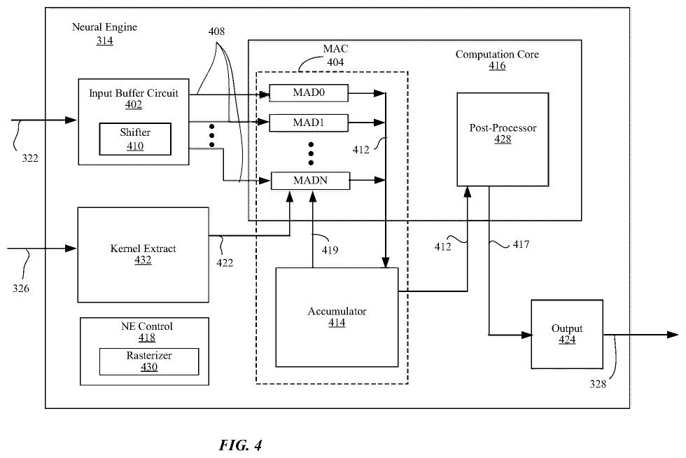

FIG. 5 is a block diagram illustrating neural task manager 310, according to some embodiments. Neural task manager 310 manages the execution of tasks for one or more neural networks by neural processor circuit 218. Neural task manager 310 may include, among other components, a task arbiter 502, task queues 504A through 504N (hereinafter collectively referred as “task queues 504” or individually as “task queue 504”), a task manager direct memory access (DMA) 506, a fetch queue 508, and a configuration queue 510. Neural task manager 310 may include other components not illustrated in FIG. 5.

Task arbiter 502 is a circuit or a combination of circuit and firmware that selects tasks from task queues 504 for execution by neural processor circuit 218. Task arbiter 502 dequeues tasks from task queues 504, and places tasks in the configuration queue 510. While a task is in a configuration queue, it is committed to execution and the neural processor circuit performs a prefetch for input data and kernel data before the task is executed by other components of the neural processor circuit 218. For example, the task arbiter 502 may perform fixed-priority arbitration between multiple task queues 504, and select the task from task queues 504 with the highest priority for retrieval of a task descriptor 512 from the system memory 230 by the task manager DMA 506.

Neural task manager 310 may include one or more task queues 504. Each task queue 504 is coupled to the CPU 208 and task arbiter 502. Each task queue 504 receives from the CPU 208 a reference to a task list that when executed by neural processor circuit 218 instantiates a neural network or a part of the neural network. The reference stored in each task queue 504 may include a set of pointers and counters pointing to task descriptors 512 stored in the system memory 230. Each task queue 504 may be further associated with a priority parameter that defines the relative priority of the task queues 504. The task descriptor of a task specifies, among other things, the configuration of neural processor circuit 218 for executing the task.

Task manager DMA 506 is coupled to task arbiter 502, system memory 230, and fetch queue 508. Task manager DMA 1006 includes a read circuit that receives task descriptors 512 of tasks from a source (e.g., system memory 230) for storing in fetch queue 508. For example, task arbiter 502 selects a task queue 504 according to the priorities of task queues 504, and uses the task list referenced by the selected task queue 504 to control the task manager DMA 506 to select the task descriptor 512 of a task.

Fetch queue 508 is a single entry queue that stores a task descriptor 512 of a task that is pending to commit for execution. Fetch queue 508 is coupled to task manager DMA 506 to receive task descriptor 512 from the system memory 230, and provides task descriptor 512 to configuration queue 510, or configuration data 514 extracted from task descriptor 512 to configuration queue 510.

Configuration queue 510 holds configuration data 514 of multiple tasks that have been committed for execution. When a task is in configuration queue 510, kernel DMA 324 may fetch kernel data from system memory 230 to store in kernel extract circuit 432 of neural engines 314, and buffer DMA 320 may fetch input data from system memory 230 to store in the data buffer 318. To execute the task, kernel extract circuit 432 provides the prefetched kernel data to MAC 404 of neural engine 314, and data buffer 318 provides the prefetched input data to MAC 404 of neural engine 314. In some embodiments, configuration queue 510 may include multiple queues that hold configuration data 514 extracted from the committed task descriptors 512. Configuration queue 510 is further coupled to other components of the neural processor circuit 218 to configure neural processor circuit 218 according to configuration data 514.

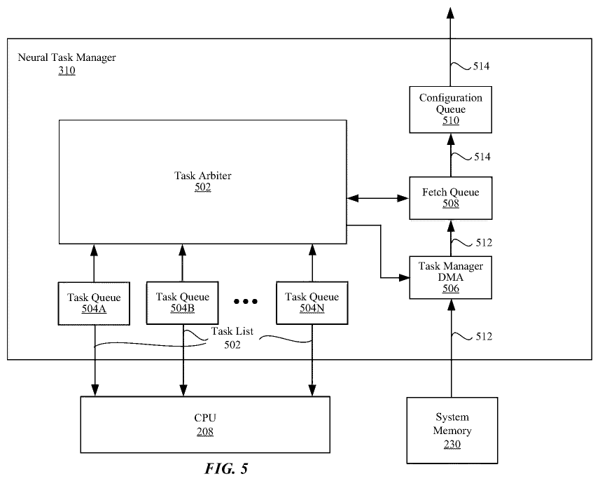

FIG. 6 is a diagram illustrating task descriptor 512, according to some embodiments. The task arbiter 502 places task descriptor 512 in fetch queue 508 from system memory 230, which is then transferred to configuration queue 510. The highest priority (e.g., first in) task descriptor 512 in configuration queue 510 is used to configure the neural processor circuit 218 for execution during the configuration period. The task descriptor 512 includes configuration data 514 including a task descriptor header 602 and address data 604A through 604N (hereinafter referred as “address data 604”). Task descriptor header 602 includes configuration data that configures various operations of the neural task manager 310, including operations related to task selection and task switching. For example, task descriptor header 602 may be parsed by task arbiter 502 to extract configuration data 514 that programs neural task manager 310 and other components of neural processor circuit 218. Task descriptor header 602 may include a task identifier (ID) 606 that identifies the task, a neural network identifier (ID) 608 that identifies a neural network instantiated by the task, a task switch parameter 610 defining whether neural task manager 310 should initiate a task switch (e.g., to execute a task of a different task queue 504 after execution of the task, an input surface parameter 612 defining whether the input data for the task should be retrieved from the system memory 230 or the data buffer 318, an output surface parameter 614 defining whether the output data of the task should be stored in the system memory 230 or the data buffer 318, various (e.g., base address) pointers 616 to facilitate the programming of the neural processor circuit 218, and one or more debug/exception parameters 618 that control event, exception, or debug logging.

Each instance of address data 604A through 604N (collectively or individually referred to as “address data 604”) defines an address and data payload pair used to program the components of the neural processor circuit 218. The data payload may indicate, among other things, which of the neural engines 314 are to be active, and whether transposer 352 in each of neural engines 314 is to be used to transpose raw input data in data buffer 318 for the task. The data payload may also include input data and kernel data used to execute the task.

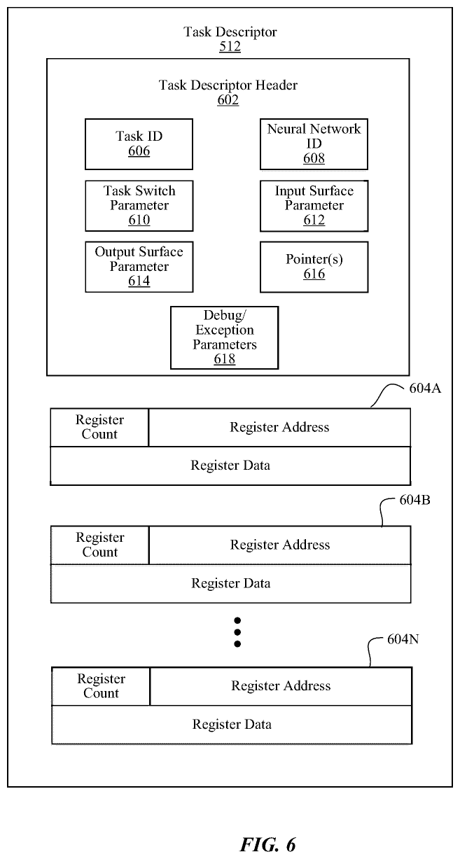

FIG. 7 is a block diagram illustrating fetch queue 508 and configuration queue 510, according to some embodiments. Configuration queue 510 is coupled to fetch queue 508, which is coupled to system memory 230 via task manager DMA 506. The configuration queue 510 is further coupled to one or more neural engines 314, data buffer 318, buffer DMA 320, kernel DMA 324 and transposer 332. Fetch queue 508 stores a task descriptor 512 (e.g., including the task descriptor header 602 and the address data 604A through 604N) for a task that is pending and not committed to execution. Fetch queue 508 reduces the latency of reading the next task descriptor 512 into configuration queue 510 from system memory 230. Fetch queue 508 stores the highest priority task descriptor 512 as determined by task arbiter 502. Task arbiter 502 may replace task descriptor 512 stored in fetch queue 508 if a higher priority task descriptor 512 has been enqueued (e.g., from a higher priority task queue 504). Task descriptor 512 in the fetch queue 508 does not initiate input data or kernel prefetch, and does not affect task queue priorities, pointers, or counters. As such, a task descriptor 512 in fetch queue 508 may be readily replaced by a higher priority task descriptor 512 by writing the higher priority task descriptor 512 into the fetch queue 1008. When a task descriptor 512 stored in the configuration queue 510 is executed by neural processor circuit 218, task descriptor 512 stored in the fetch queue 508 is transferred to the configuration queue 510, and another task descriptor 512 of a subsequent task may be stored in the fetch queue 508.

Configuration queue 510 stores task descriptors 512 of tasks committed for execution by the neural processor circuit 218. In some embodiments, the configuration queue 510 includes multiple separate queues 710A through 710N that each stores a portion of configuration data 514 (including configuration data 514A through 514E) extracted from task descriptor 512. Furthermore, queues 710A through 710N are each coupled to a respective component of the neural processor circuit 218 for programming the component with the configuration data 1014. Through the operation of configuration queue 510, neural task manager 310 programs the components of the neural processor circuit 218.

### Data Layout Format and Operations at Neural Processor Circuit

Depending on the neural network operations and the configuration of hardware for executing a neural network, one type of data layout format may be advantageous over another type of data layout for processing by neural processor circuit 218. A width-last format such as NCHW format can be used to process spatial data (e.g., image data) to take advantage of parallel processing in spatial dimension while a channel-last format such as NHWC is more advantageous for temporal data (e.g., audio data) since there is minimal or no parallelism across spatial dimension. Hence, it is advantageous to switch between the width-last format and the channel-last format for processing at the neural processor circuit, depending on the nature of the input data and applications.

Striding also affects the efficiency of the data layout format for input data. A stride is a parameter that specifies the step size for moving a filter for convolution across the input data. If a stride of 3 in the width direction is used, every third input data in the width direction is fetched and multiplied with a filter value in a kernel. The benefit of using the channel-last format is further useful when there is a stride in the width direction of the input data. If a large stride in the width direction is used, the input data elements of different channels after skipping in the width direction are located in adjacent memory locations of data buffer 318. Hence, in the channel-last format, input data elements for the different channels after the skipping may be fetched from adjacent memory locations of data buffer 318, enabling more efficient data fetching. In contrast, when the same striding is applied to input data in the width-last format, the input data elements for fetching are scattered across different memory locations in data buffer 318, which renders the data fetching of the input data elements inefficient.

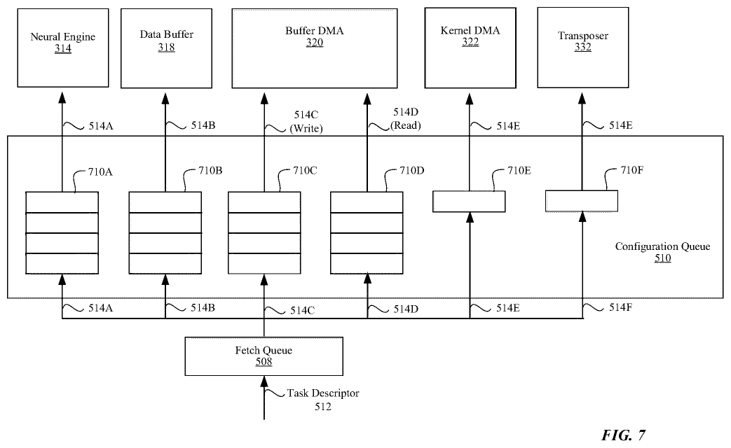

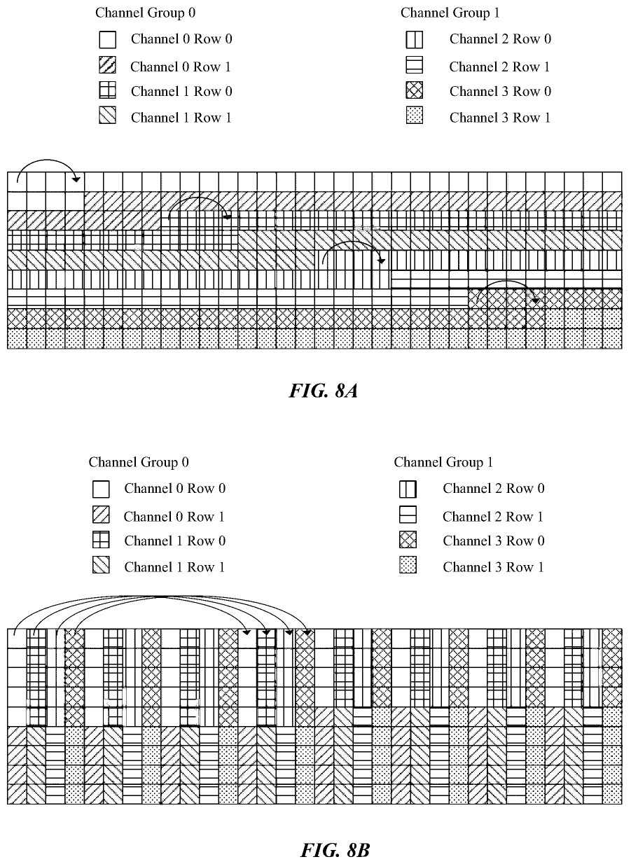

FIG. 8A is a diagram illustrating input data stored in the NCHW format, according to some embodiments. FIG. 8B is a diagram illustrating the same input data in the NHWC format, according to some embodiments. In the examples of these figures, a batch of data has a dimension of 32×9 elements, which includes two rows of elements from each of four different channels where each row of a channel has 36 elements. Two channels are grouped into two channel groups 0 and 1 where channels 0, 1 are assigned to channel group 0 while channels 2and 3 are assigned to channel group 1. In the NCHW format, data elements of the same channel are stored sequentially in data buffer 318 as shown in FIG. 8A. Conversely, in the NHWC format, the data elements of different channels are stored in an alternating manner as shown in FIG. 8B.

Neural processor circuit 218 advantageously switches the data layout format for input data fed into neural engines 314 on a task-by-task basis, according to the data format of the input data. Each of the tasks is associated with task descriptor 512 which indicates whether the input data to neural engines 314 should be in a width-last format or a channel-last format. From such task descriptor 512, configuration data 514 for setting components of neural processor circuit 218 are extracted. For example, transposer 332 is activated or deactivated, one or more neural engines 314 are activated or deactivated, and data flow to and from data buffer 318 is coordinated according to configuration data 514.

If the channel-last format is used as the input data, neural processor circuit 218 is operated in the channel-last mode where transposer 332 is activated to transpose the raw (or original) input data in data buffer 318 into transposed input data, and then send the transposed input data from data buffer 318 to one or more neural engines 314. In some embodiments, only one neural engine (e.g., neural engine 314A) is activated while the remaining neural engines 314 (e.g., neural engines 314 B through 314N) are deactivated in the channel-last mode. Further, in the channel-last mode, output data 328 stored in data buffer 318 of the channel-last format may be transposed back into the width-last format before being sent out system memory 230.

Conversely, if the width-last format is used as the input data, neural processor circuit 218 is operated in the width-last mode where transposer 332 is deactivated or used only for memory operations associated with data stored in data buffer 318, and multiple neural engines 314 are activated and operated in parallel to perform the convolution operations. Further, output data 328 stored in data buffer 318 is sent to a target (e.g., system memory) without transposing the output data by transposer 332.

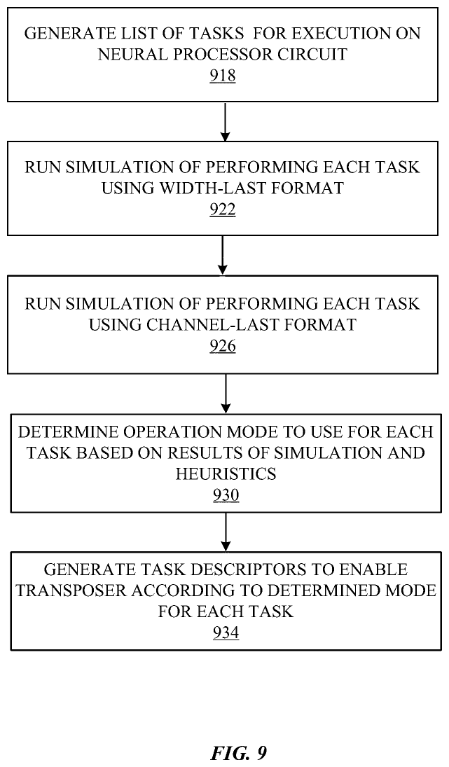

Arrows in FIGS. 8A and 8B illustrate the data elements to be fetched when a stride value of 3 in the width direction is used. In these figures, the starting points of the arrows indicate the first set of data elements in each channel to be fetched from data buffer 318 for processing while the ending points of the arrows indicate the next set of data elements in each channel to be fetched from data buffer 318 for processing. As shown in FIG. 8A, the second set of data elements to be fetched is spread out across various memory locations of data buffer 318 when the NCHW format is used. Hence, when the NCHW format is used, a multiplexing scheme is performed for a supported stride value to forward appropriate data elements from data buffer 318 to MAC 404 of neural engine 408. The scattering of data elements to be fetched is exacerbated in the NCHW format, rendering reading operations of the data from data buffer 318 inefficient and time-consuming. In contrast, when NHWC format is used as shown in FIG. 8B, the first set of data elements in different channels to be fetched as well as the next set of data elements to be fetched are located at adjacent memory locations. Such adjacent locating of the data elements in NHWC obviates the multiplexing scheme used in NCHW format. Hence, in some embodiments, if there is a stride in the width direction with a corresponding stride value above a threshold, neural processor circuit 218 is operated in the channel-last mode. In contrast, if there is no stride in the width direction or the stride value is at or below the threshold, neural processor circuit 218 is operated in the width-last mode since complication or inefficiency associated with reading of the data from data buffer 318 is decreased. The selection of the operation mode based on the stride value may be incorporated into heuristics described below in detail with reference to FIG. 9.

In some embodiments, neural processor circuit 218 may operate in modes other than the width-last mode or the channel-last mode described above. Further, neural processor circuit 218 may take various other configurational or operational changes when operating in the width-last mode or the channel-last mode.

### Determining Data Layout Format at Compiler

Compiler 336 is software that translates neural network models into machine code for execution by neural processor circuit 218. Compiler 336 performs various operations, including but not limited to, parsing and converting a neural network model into a graph, determines the dimensions of kernels and input data, configures data flow between the components of neural processor circuit 218, executes optimization algorithms, and generates the tasks descriptors as the machine code for configuring the components of neural processor circuit 218. The optimization algorithms may determine whether to place neural processor circuit 218 in the width-last mode or the channel-last mode to perform a task.

FIG. 9 is a flowchart illustrating a method of generating a task descriptor for neural processor circuit 218 to determine the mode of operation for neural processor circuit 218, according to some embodiments. Compiler 336 generates 918 a list of tasks corresponding to a neural network by parsing and converting the neural network model. Among other operations associated with each of the tasks, compiler 336 determines a data layout format for the task that is appropriate as input data for feeding into one or more neural engines 314 of neural processor circuit 218. The data layout format may be, among other things, the width-last format and the channel-last format. To perform the task, neural processor circuit 218 may be placed in the width-last mode or the channel-last mode depending on the data layout format determined to be appropriate for the task.

Compiler 336 runs 922 a simulation of performing each of the tasks using the width-last format. During the simulation of using the width-last format, transposer 332 is assumed as not being used or being used only for memory operations associated with the input data or the output data. As a result of the simulation, simulation output parameters such as the estimated execution time of the task and the power consumption, the memory space usage of data buffer 318, and the bandwidth usage of kernel DMA 324, for operating in the width-last mode, are obtained. Similarly, compiler 336 runs 926 a simulation of performing the same task using the channel-last format. During the simulation of using the channel-last format, transposer 332 is assumed to perform the transpose operation on the input data in data buffer 318 before feeding into neural engines 314, and is also assumed to perform the transpose operation on the output data in data buffer 318 before being sent to system memory 230. As a result, simulation output parameters for performing the task in the channel-last mode are obtained.

Alternatively, or in addition to the simulation, compiler 336 may use heuristics based on various factors to determine the operation mode to be used for each tasks. The heuristics may indicate the preferred use of the width-last format or the channel-last format depending on, for example, (i) the source of input data (e.g., image sensor or microphone), (ii) the number of channels of input data, (iii) the size of batch for processing, (iv) whether a stride in the width direction of the input data is larger than a threshold value, and (v) the width of a tensor in input data. If the stride in the width direction in the input data is larger than the threshold value, the channel-last mode may be preferred over the width-last mode.

Compiler 336 determines 930 the operation mode (e.g., width-last mode or channel-last mode) to be used for each of the tasks based on one or more of the simulation results and heuristics or both.

After the data layout format is determined, compiler 336 generates 934 a task descriptor for the task to enable or disable transposer 332 to perform the transpose operations. That is, if the width-last mode was selected to perform the task, then transposer 332 is disabled for the transpose operations on the input data and the output data. Conversely, if the channel-last mode was selected to perform the task, then transposer 332 is enabled to perform the transpose operation on the input data and the output data.

The process of receiving 918 the task through generating 934 the task descriptor may be repeated for each task in the task list. Alternatively, the process may be repeated for a subset of the tasks in the task list.

The operations and their sequences described above with reference to FIG. 9 are merely illustrative and various changes or modifications may be made. For example, heuristics may be used to select a subset of tasks for simulation. That is, the heuristics may first be applied to the tasks and then only the subset of tasks that are unclear in terms of a more efficient data layout format may be simulated to determine the use of width-last mode or the channel-last mode for the subset of tasks. Further, the simulation of performing the task using the channel-last format may be executed 926 before running 922 the simulation of performing the task using the width-last format, or the two simulations may be performed in parallel.

### Operating Neural Processor Circuit with Different Data Layout Format

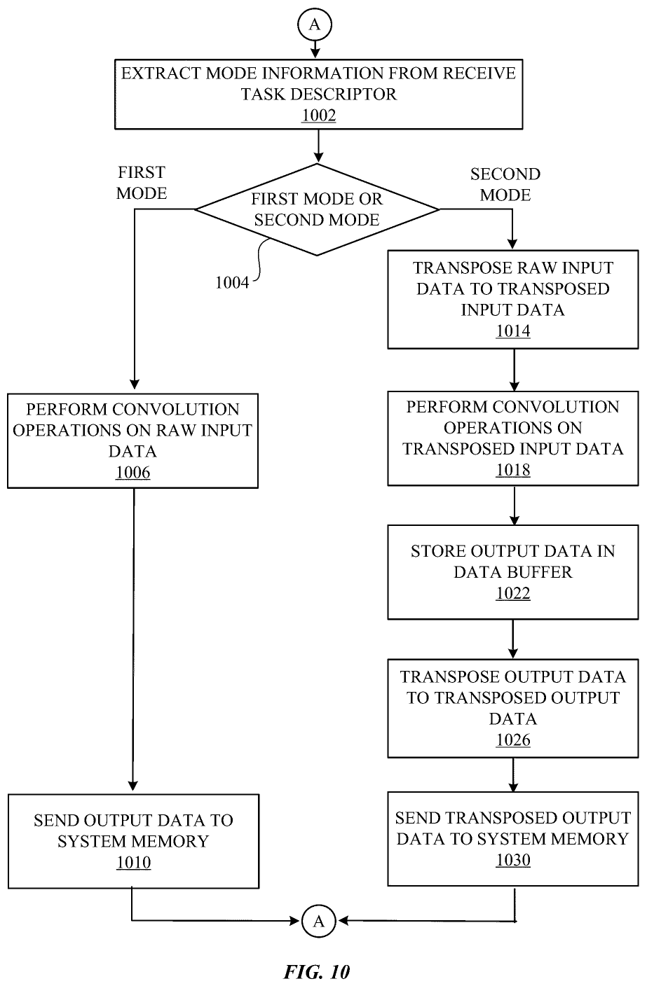

FIG. 10 is a flowchart illustrating a method of performing neural network operations at neural processor circuit 218, according to some embodiments. When a task is scheduled for execution on neural processor circuit 218, mode information indicating the data layout format to be used is extracted 1002 from a task descriptor corresponding to the task. The mode information may be in the form of configuration data 514 described above in detail with reference to FIG. 5, and indicates, among other things, the configuration and operations of components of neural processor circuit 218 for the task so that neural processor circuit 218 may be operated in the first mode (e.g., width-first mode) or the second mode (e.g., channel-last mode).

Based on the extracted mode information, it is determined 1004 whether neural processor circuit 218 is to be operated in the first mode or the second mode. When it is determined that neural processor circuit 218 is to be operated in the first mode, raw input data in data buffer 318 as received from system memory 230 or other sources in the width-last format is fed to one or more neural engines 314 to perform 1006 convolution operations without performing transpose operations on the raw input data.

For this purpose, transposer 332 is configured by configuration data 514 not to perform any tensor transpose operations on the input data or the output data. The output data that results from the convolution operations are stored in data buffer 318. Data buffer 318 is also configured by configuration data 514 not to send the input data or the output data to transposer 332 for transposing operations. Further, two or more neural engines 314 may be activated to perform their operations in parallel.

The output data stored in data buffer 318 is then sent 1010 to a target (e.g., system memory 230) without transposing the output data.

If it is determined that the second mode is to be used, raw input data, as stored in system memory 230, is transposed 1014 by transposer 332 into transposed input data. The raw input data may be in the width-last format and the transposed input data may be in the channel-last format. The transposed input data is stored in data buffer 318 and then sent to one or more neural engines 314 to perform 1018 convolution operations.

For this purpose, transposer 332 may be activated by configuration data 514. Further, data buffer 318 may be instructed by configuration data 514 to send raw input data and the output data to transposer 332 to undergo transposing operations. In some embodiments, only a single neural engine 314 (e.g., neural engine 314A) is activated by configuration data 514 in the second mode.

The results of the convolution operations in the form of output data from one or more neural engines 314 are stored 1022 in data buffer 318. Then, the output data is transposed 1026 by transposer 332 to transposed output data for stored in data buffer 318. The transposed output data is sent 1030 to system memory 230. The output data may be in the channel-last format while the transposed output data may be in the width-last format.

The operations and their sequence in FIG. 10 are merely illustrative and various changes may be made. For example, the output data in the second mode may be sent without performing transposing 1026 to system memory 230. As another example, transposer 332 may be used in the first mode and/or the second mode to perform memory operations on data stored in data buffer 318. Furthermore, modes other than the first mode and the second mode may be used. In such case, further sequence of operations may be performed for these other modes.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural processor circuit, comprising:
a plurality of neural engine circuits configured to perform convolution operations on input data to generate output data;
a data buffer circuit between the plurality of neural engine circuits and a memory external to the neural processor circuit, the data buffer circuit configured to store:
raw input data for sending to the plurality of neural engine circuits as the input data in a first mode;
transposed input data for sending to the plurality of neural engine circuits as the input data in a second mode; and
the output data received from the plurality of neural engines; and
a transposer circuit coupled to the data buffer circuit, the transposer circuit configured to receive the raw input data and transpose the raw input data into the transposed input data in the second mode.

2. The neural processor circuit of claim 1, wherein the raw input data is in a width-last format and the transposed input data is in a channel-last format.

3. The neural processor circuit of claim 2, wherein the transposer circuit is further configured to, in the second mode, receive the output data from the plurality of neural engine circuits and transpose the output data into transposed output data for storing in the data buffer circuit.

4. The neural processor circuit of claim 3, wherein the transposer circuit is configured to perform memory operations for the data buffer circuit in the first mode.

5. The neural processor circuit of claim 1, further comprising a neural task manager configured to:
receive a list of tasks to be performed by the neural processor circuit;
receive task descriptors for each of the tasks indicating configuration of the neural processor circuit to operate in the first mode or the second mode;
extract configuration data from the task descriptors; and
send the configuration data to the plurality of neural engine circuits and the transposer circuit to configure the plurality of neural engine circuits and the transposer circuit to operate in the first mode or the second mode.

6. The neural processor circuit of claim 5, wherein the neural task manager is configured to receive the list of tasks from a compiler configured to determine whether each of the tasks is to be performed in the first mode or the second mode.

7. The neural processor circuit of claim 6, wherein the compiler is configured to determine whether each of the tasks is to be performed in the first mode or the second mode by at least running simulations of the task in the first mode and the second mode.

8. The neural processor circuit of claim 1, wherein one of the plurality of neural engine circuits is configured to be active and others of the plurality of neural engine circuits are configured to be inactive in the second mode.

9. The neural processor circuit of claim 8, wherein the one of the plurality of neural engine circuits is configured to have bandwidth for receiving the input data that is higher than that of the others of the plurality of neural engine circuits.

10. The neural processor circuit of claim 9, wherein the one of the plurality of neural engine circuits is configured to have bandwidth for receiving kernel data that is higher than that of the others of the plurality of neural engine circuits, wherein the kernel data is used for performing the convolution operations.

11. The neural processor circuit of claim 1, wherein, in the second mode, the raw data is associated with a stride in a width direction, the stride indicating a number of input elements by which a kernel moves across in a convolution operation performed at the plurality of neural engine circuits.

12. A method of operating a neural processor circuit, comprising:
receiving raw input data for storing in a data buffer circuit of the neural processor circuit;
in a first mode:
sending the raw input data from the data buffer circuit to a plurality of neural engine circuits;
performing convolution operations on the raw input data to generate output data; and
storing the generated output data in the data buffer circuit;
in a second mode:
transposing the raw input data into transposed input data by a transposer circuit in the neural processor circuit;
storing the transposed input data in the data buffer circuit;
sending the transposed input data from the data buffer circuit to the plurality of neural engine circuits; and
performing convolution operations on the transposed input data to generate the output data; and
storing the output data in the data buffer circuit.

13. The method of claim 12, wherein the raw input data is in a width-last format and the transposed input data is in a channel-last format.

14. The method of claim 13, further comprising:
in the second mode:
transposing the output data into transposed output data by the transposer circuit;
storing the transposed output data in the data buffer circuit; and
sending the transposed output data to a memory that is external to the neural processor circuit.

15. The method of claim 14, further comprising performing memory operations by the transposer circuit for the data buffer circuit in the first mode.

16. The method of claim 12, further comprising:
receiving a list of tasks to be performed by the neural processor circuit,
receiving task descriptors for each of the tasks indicating configuration of the neural processor circuit to operate in the first mode or the second mode;
extracting configuration data from the task descriptors; and
sending the configuration data to the plurality of neural engine circuits and the transposer circuit to configure the plurality of neural engine circuits and the transposer circuit to operate in the first mode or the second mode.

17. The method of claim 16, further comprising determining, by a compiler, whether each of the tasks is to be performed in the first mode or the second mode by at least running simulations of the task in the first mode and the second mode.

18. The method of claim 12, further comprising, in the second mode, activating one of the plurality of neural engine circuits and inactivating others of the plurality of neural engine circuits.

19. The method of claim 12, wherein, in the second mode, the raw data is associated with a stride in a width direction, the stride indicating a number of input elements by which a kernel moves across in a convolution operation performed at the plurality of neural engine circuits.

20. An integrated circuit (IC) system, comprising:
a neural processor circuit, the neural processor circuit comprising:
a plurality of neural engine circuits;
a data buffer circuit configured to store:
raw input data for sending to the plurality of neural engine circuits as the input data in a first mode;
transposed input data for sending to the plurality of neural engine circuits as the input data in a second mode; and
the output data received from the plurality of neural engines; and
a transposer circuit coupled to the data buffer circuit and configured to receive the raw input data and transpose the raw input data into the transposed input data in the second mode; and
a memory coupled to the data buffer circuit.
